(19) United States
(12) Patent Application Publication
(10) Pub. No.: US 2016/0119839 A1
(43) Pub. Date: Apr. 28, 2016

(54) COMMUNICATION APPARATUS, COMMUNICATION SYSTEM, AND COMMUNICATION CONTROL METHOD

(71) Applicant: KYOCERA CORPORATION, Kyoto (JP)

(72) Inventor: Mayumi KOMURA, Yokohama-shi (JP)

(21) Appl. No.: 14/894,496

(22) PCT Filed: May 28, 2014
(86) PCT No.: PCT/JP2014/002822

§ 371 Date: Nov. 27, 2015

(30) Foreign Application Priority Data
May 28, 2013 (JP) 2013-112200

(51) Int. Cl. H04W 36/08; H04B 7/02; H04W 8/22

(52) U.S. Cl. CPC H04W 36/08; H04W 8/22; H04B 7/024

(57) ABSTRACT

A communication apparatus 101 of the disclosure herein employing a communication standard different from that of a base station 103 having a baseband unit 105 and at least one remote radio unit 107 connected to the baseband unit via a wired line, the communication apparatus 101 having an interface unit connected to the remote radio unit 107 and a controller for controlling the interface unit to transmit, via the wired line 109, communication-related information of the communication apparatus 101 to at least one other communication apparatus 101 connected to the remote radio unit 107.

### CROSS REFERENCE TO RELATED APPLICATION

This application claims priority to and the benefit of Japanese Patent Application No. 2013-112200 (filed on May 28, 2013), the entire contents of which are incorporated herein by reference.

### TECHNICAL FIELD

This disclosure relates to a communication apparatus, a communication system, and a communication control method.

### BACKGROUND

A base station (referred to as an LTE base station) in an LTE (Long Term Evolution) system may have a configuration in which a remote radio unit (RRU: Remote radio unit) is separate from a baseband unit (BBU: Base Band Unit). The base station having such a configuration is referred to as an optical feeder base station. The optical feeder base station may have the remote radio unit installed in a protruding manner and thus is desired to expand a communication area. The remote radio unit and the baseband unit are connected to each other via an optical line such as an optical fiber, and the connection employs an interface such as CPRI (Common Public Radio Interface), OBSAI (Open Base Station Architecture Initiative), or the like. The interface employs topology such as a chain, a star, a ring, or the like and allows connection of a plurality of remote radio units to one baseband unit (for example, see PLT 1 set forth below). Installation of a plurality of remote radio units allows the use of techniques for improving communication quality such as handover between the remote radio units and CoMP (Coordinated Multi-Point).

### CITATION LIST

### Patent Literature

PLT 1: JP2010268192A

### SUMMARY

### Technical Problem

Conventionally, a base station (a communication apparatus) (hereinafter, referred to as a PHS base station) of PHS (Personal Handy-phone System) employing a communication standard different from that of the LTE, unlike the LTE base station, cannot have a configuration in which the remote radio unit and the baseband unit are separated from each other. Therefore, the PHS is not ready for an optical line environment for connecting between base stations. As such, the PHS base station is assumed to connect to the remote radio unit of the LTE base station so as to be able to utilize the optical line environment of the LTE base station. However, even when the PHS base station is connected to each of a plurality of remote radio units of the LTE base station, a method of controlling all of the PHS base stations has not yet been considered.

In consideration of the above problem, accordingly, it could be helpful to provide a communication apparatus, a communication system, and a communication control method those capable of operating by using the base stations those employing different communication standards.

### Solution to Problem

In order to solve the above problem, a communication apparatus according to a first aspect of the disclosure herein is a communication apparatus employing a communication standard different from that of a base station having a baseband unit and at least one remote radio unit connected to the baseband unit via a wired line, the communication apparatus including:

an interface unit connected to the remote radio unit; and

a controller for controlling the interface unit to transmit, via the wired line, communication-related information of the communication apparatus to at least one other communication apparatus connected to the remote radio unit.

A second aspect of the disclosure herein is the communication apparatus according to the first aspect, wherein the communication-related information is information necessary to perform handover between the communication apparatus and the one other communication apparatus.

A third aspect of the disclosure herein is the communication apparatus according to the first aspect, wherein the communication-related information is information necessary to perform CoMP between the communication apparatus and the one other communication apparatus.

A fourth aspect of the disclosure herein is the communication apparatus according to the first aspect, wherein the interface unit, from the remote radio unit connected to the interface unit, receives information necessary to perform handover to the remote radio unit.

A fifth aspect of the disclosure herein is the communication apparatus according to the first aspect, wherein, when the base station is a base station employing an LTE system, the communication apparatus is a base station employing PHS.

A communication system according to a sixth aspect of the disclosure herein is a communication system having a plurality of communication apparatuses according to claim 1, at least one remote radio unit connected to the communication apparatus, and a baseband unit.

Although the apparatus has been described above as the solution of the disclosure herein, a method, a program, and a storage medium storing the program those substantially corresponding to the apparatus may implement the disclosure herein and thus are included in the scope of the disclosure.

For example, a communication control method according to a sixth aspect of the disclosure herein implementing the communication apparatus according to the first aspect as a method is a communication control method of a communication apparatus employing a communication standard different from that of a base station having a baseband unit and at least one remote radio unit connected to the baseband unit via a wired line, the communication control method including:

a step of connecting to the remote radio unit; and

a step of transmitting, via the wired line, communication-related information of the communication apparatus to at least one other communication apparatus connected to the remote radio unit.

### Advantageous Effect

Our communication apparatus, communication system, and communication control method as described above may operate by using a base station employing a different communication standard.

### BRIEF DESCRIPTION OF THE DRAWINGS

In the accompanying drawings:

FIG. 1 is a diagram illustrating a schematic configuration of a communication system according to a first embodiment;

FIG. 2 is a functional block diagram illustrating a schematic configuration of a PHS base station according to the first embodiment;

FIG. 3 is a flowchart illustrating an operation of the PHS base station according to the first embodiment;

FIG. 4 is a flowchart illustrating an operation of the PHS base station according to a second embodiment; and

FIG. 5 is a diagram illustrating a schematic configuration of a communication system according to an exemplary variation of the embodiments.

### DETAILED DESCRIPTION

Hereinafter, embodiments of the disclosure herein applying our communication apparatus to a base station of a PHS system (a PHS base station) will be described with reference to the accompanying drawings. Note that our communication apparatus is also applicable to, other than the PHS base station, for example, an access point of a wireless LAN (Local Area Network).

### First Embodiment

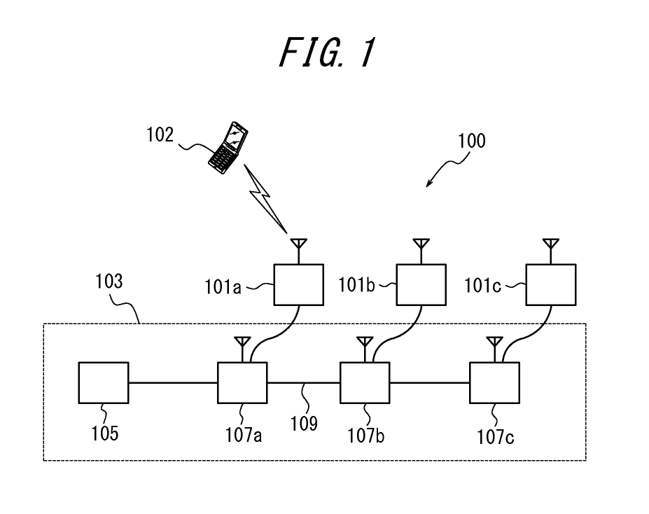

FIG. 1 is a diagram illustrating a schematic configuration of a communication system according to a first embodiment of the disclosure herein. A communication system 100 includes PHS base stations 101 (101a, 101b, and 101c), a communication terminal 102 for communicating with the PHS base stations 101, and a base station 103 employing a communication standard different from that of the PHS base stations 101. According to the present embodiment, hereinafter, the base station 103 is a base station employing an LTE system (an LTE base station). The LTE base station 103 includes a baseband unit 105 and at least one remote radio unit 107 (107a, 107b, and 107c). The baseband unit 105 and the remote radio unit 107 are connected to each other via a wired line 109. The wired line 109 is, for example, an optical fiber, in which case the LTE base station 103 is an optical feeder base station. Note that a network topology configuration of the LTE base station 103 is not limited to a chain shape as illustrated in FIG. 1 but may have a star shape or a ring shape. Also, although in FIG. 1 one PHS base station 101 is connected to one remote radio unit 107, the disclosure herein is not limited to this manner. For example, a plurality of PHS base stations 101 may be connected to one remote radio unit 107.

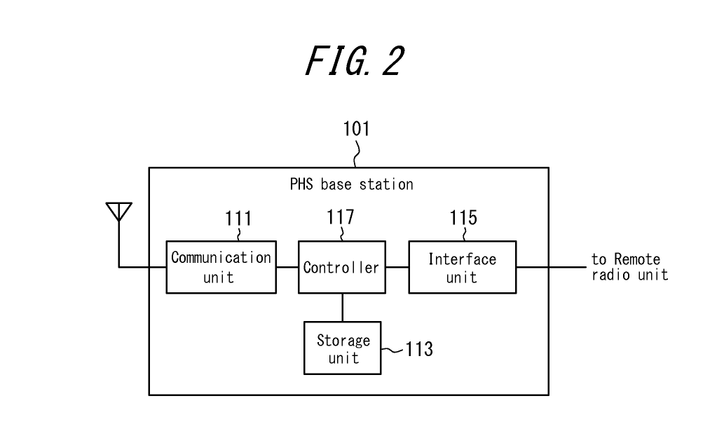

FIG. 2 is a functional block diagram illustrating a schematic configuration of the PHS base station according to the first embodiment. The PHS base station 101 according to the present embodiment includes a communication unit 111, a storage unit 113, an interface unit 115, and a controller 117. The communication unit 111, the storage unit 113, and the interface unit 115 are connected to the controller 117. The interface unit 115 is also connected to the remote radio unit 107 of the LTE base station 103 via the wired line 109.

The communication unit 111 exchanges radio signals with the communication terminal 102 via an antenna.

The storage unit 113 stores various information including communication-related information of the PHS base station 101 and functions as a work memory or the like. The communication-related information is, for example, information (essential handover information) necessary to perform handover between the PHS base stations 101. The essential handover information includes, in particular, identification information (ID) of the communication terminal 102 in communication with the PHS base station 101, information on an available radio resource that may be assigned to the communication terminal 102 by the PHS base station 101, information on quality of the available radio resource specified by carrier sense or the like, information on a location of the PHS base station 101, and the like. According to the present embodiment, hereinafter, the communication-related information is the essential handover information.

The interface unit 115, via the wired line 109, connects to and communicates with the remote radio unit 107 to exchange the signals therewith. The interface unit 115 is, for example, CPRI, OBSAI, or Ethernet (registered trademark) that is employed by the remote radio unit 107.

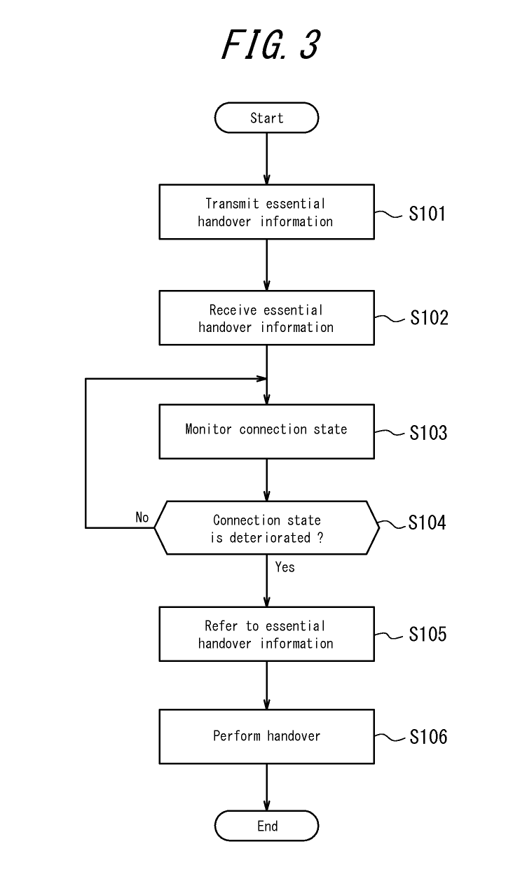

The controller 117 controls and manages the entire PHS base station 101 including each functional block thereof. The controller 117 may be constituted by using software executed by any appropriate processor such as a CPU (Central Processing Unit), or a dedicated processor (for example, DSP (Digital Signal Processor)) specialized for each operation. An operation carried out by the controller 117 will be described in detail below with reference to FIG. 3.

Referring to FIG. 3, next, the operation carried out by the PHS base station 101a will be described. FIG. 3 is a flowchart illustrating the operation of the PHS base station according to the first embodiment. Note that the functional block of the PHS base station 101 illustrated in FIG. 2 is commonly applicable to the PHS base stations 101a, 101b, and 101c. Reference signs of components in the functional blocks of the base station 101a, the base station 101b, and the base station 101c are denoted by a, b, and c, respectively.

First, a controller 117a of the PHS base station 101a, periodically or non-periodically, generates the essential handover information as the communication-related information. Then, the controller 117a controls an interface unit 115a to transmit the essential handover information (step S101). Thereby, the essential handover information reaches other PHS base stations (other communication apparatuses) 101b and 101c via the remote radio unit 107 and the wired line 109.

Similarly, a controller 117b of the PHS base station 101b and a controller 117c of the PHS base station 101c, periodically or non-periodically, generate respective essential handover information. Then, the controller 117b and the controller 117c transmit the respective essential handover information from an interface unit 115b and an interface unit 115c, respectively. Thereby, the PHS base station 101a receives the essential handover information of the PHS base station 101b and the essential handover information of the 101c (step S102). Then, the controller 117a of the PHS base station 101a stores the essential handover information of these PHS base stations in a storage unit 113a.

Since the PHS base stations 101a, 101b, and 101c transmit the respective handover information to the PHS base stations other than the PHS base station of its own by using the wired line 109 of the LTE base station 103, the essential handover information is shared among the PHS base stations. Note that the essential handover information may be transmitted either to all of the PHS base stations other than the PHS base station of its own or to a specific PHS base station.

Subsequently, the PHS base station 101a monitors a connection state of a connection to the communication terminal 102 (step S103). In particular, the controller 117a of the PHS base station 101a obtains information indicative of the connection state. For example, the controller 117a, based on a reception signal from the communication terminal 102, calculates a value indicative of reception quality such as SNR (Signal to Noise Ratio), CNR (Carrier to Noise Ratio), SINR (Signal to Interference and Noise Ratio), CINR (Carrier to Interference and Noise Ratio), and the like. According to the present embodiment, hereinafter, the controller 117a, for monitoring the connection state, calculates the value of the SNR. The greater the value of the SINR, the better the indicated connection state.

The controller 117a monitors the communication state of the connection to the communication terminal 102 and, also, determines whether the connection state is deteriorated (step S 104). For example, in order to calculate the SNR, the controller 117a compares the SNR to a threshold value that ensures stable communication. The threshold value is preliminarily stored in the storage unit 113a to be retrieved. When the SNR is equal to or greater than the threshold value (No at step S104), the controller 117a determines that the connection state of the connection to the communication terminal 102 is good and continues monitoring the connection state (step S103).

On the other hand, when the SNR is equal to or below the threshold value (Yes at step S104), the controller 117a determines that the connection state of the connection to the communication terminal 102 is deteriorated and there is a risk that stable communication with the communication terminal 102 may become difficult. In this case, the communication terminal 102 needs to perform handover in order to maintain the communication.

As such, the controller 117a refers to the essential handover information stored in the storage unit 113a and specifies a handover destination of the communication terminal 102 (step S105). According to the present embodiment, it is assumed that the PHS base station 101b has a radio resource that enables stable communication with the communication terminal 102. In this case, the controller 117a, based on the essential handover information including radio resource information and the like, determines the PHS base station 101b as the handover destination. Note that, when a PHS base station other than the PHS base station 101a is connected to the remote radio unit 107a, the controller 117a may select the PHS base station connected to the remote radio unit 107a as the handover destination.

Then, the controller 117a executes a handover operation to allow the communication terminal 102 to change its connection destination to the PHS base station 101b (step S106). In particular, the controller 117a generates a terminal instruction signal for instructing the communication terminal 102 to change its connection destination to the PHS base station 101b. Then, the controller 117a wirelessly transmits the terminal instruction signal to the communication terminal 102 via the communication unit 111a. Also, the controller 117a generates a base station instruction signal for instructing the PHS base station 101b to secure a radio resource for communication with the communication terminal 102 and establish the connection to the communication terminal 102. Then, the controller 117a controls the interface unit 115a to transmit the base station instruction signal to the PHS base station 101b via the remote radio units 107a and 107b and the wired line 109. Accordingly, the handover may be performed by using the wired line 109 of the LTE base station 103.

According to the present embodiment, as described above, the controller 117 of the PHS base station 101 controls the interface unit 115 to transmit, via the wired line 109, the essential handover information serving as the communication-related information of the PHS base station 101 to another PHS base station 101 connected to the remote radio unit 107 of the LTE base station 103. That is, via the LTE base station 103, the essential handover information is shared between a plurality of PHS base stations 101. Therefore, the PHS base station 101a, when the connection state of the connection to the communication terminal 102 becomes deteriorated, may specify the PHS base station 101b as the handover destination based on the essential handover information. Then, the PHS base station 101a, by using line network of the LTE base station 103, may instruct the PHS base station 101b to perform handover and communicate with the communication terminal 102. In this manner, the PHS base station 101a may substantialize the handover operation by using the LTE base station 103 employing a different communication standard.

### Second Embodiment

In the first embodiment, the handover operation by using the LTE base station 103 has been described. In a second embodiment, a CoMP operation by using a base station that employs a different communication standard will be described.

A communication system 200 according to the second embodiment, similarly to the communication system 100 according to the first embodiment, includes PHS base stations 201 (201a, 201b, and 201c), a communication terminal 202 for communicating with the PHS base stations 201, and an LTE base station 203 that employs a communication standard different from that of the PHS base stations 201. The LTE base station 203 includes a baseband unit 205 and remote radio units 207 (207a, 207b, and 207c) connected to each other via a wired line 209. A configuration of these components is the same as that of the first embodiment, and thus a description thereof will be omitted.

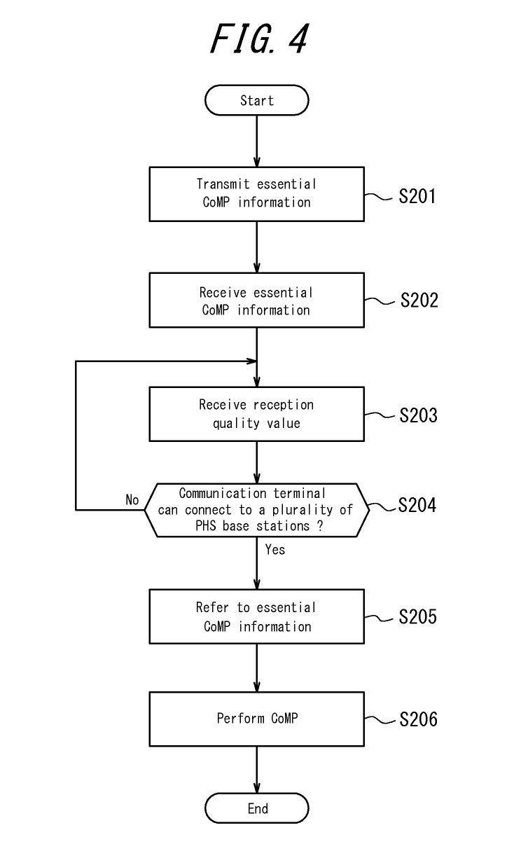

A functional block of the PHS base station 201 according to the second embodiment, similarly to that of the first embodiment, includes a communication unit 211, a storage unit 213, an interface unit 215, and a controller 217. In the functional block, since the communication unit 211 and the interface unit 215 function in a manner similar to the communication unit 111 and the interface unit 115 of FIG. 2, respectively, descriptions thereof will be omitted. An operation carried out by the controller 217 will be described in detail with reference to FIG. 4.

According to the second embodiment, the storage unit 213 stores, as the communication-related information, information (essential CoMP information) necessary for the PHS base stations 201 to perform a communication operation therebetween by using the CoMP. The essential CoMP information includes, in particular, identification information (ID) of the communication terminal 202 in communication with the PHS base station 201, information on a location of the communication terminal 202, information on an available radio resource that may be assigned to the communication terminal 202 by the PHS base station 201, information on quality of the available radio resource specified by the carrier sense or the like, identification information of the PHS base station 201, and the like.

Referring to FIG. 4, next, the operation of the PHS base station 201a will be described. FIG. 4 is a flowchart illustrating the operation of the PHS base station according to the second embodiment. Similarly to the first embodiment, reference signs of components in the functional blocks of the base station 201a, the base station 201b, and the base station 201c are denoted by a, b, and c, respectively. Hereinafter, also, the CoMP refers to joint transmission (Joint Transmission), which is one of joint signal processing (Joint Processing). However, the disclosure herein is not limited to the joint transmission. For example, the PHS base station 201 may perform dynamic cell selection (Dynamic Cell Selection) as the CoMP. The joint signal processing is a control that makes a plurality of PHS base stations to simultaneously transmit signals to one communication terminal by using a radio resource at the same frequency in the same time.

First, a controller 217a of the PHS base station 201a, periodically or non-periodically, generates the essential CoMP information as the communication-related information. Then, the controller 217a controls an interface unit 215a to transmit the essential CoMP information (step S201). Thereby, the essential CoMP information reaches other PHS base stations (other communication apparatuses) 201b and 201c via the remote radio unit 207 and the wired line 209.

Similarly, a controller 217b of the PHS base station 201b and a controller 217c of the PHS base station 201c, periodically or non-periodically, generate the respective essential CoMP information. Then, the controller 217b and the controller 217c transmit the respective essential CoMP information from the interface unit 215b and the interface unit 215c, respectively. Thereby, the PHS base station 201a receives the essential CoMP information of the PHS base station 201b and the essential CoMP information of the PHS base station 201c (step S202). Then, the controller 217a of the PHS base station 201a stores the essential CoMP information of these base stations in a storage unit 213a.

Since each of the PHS base stations 201a to 201c transmits the respective essential CoMP information to the PHS base stations other than the PHS base station of its own, the essential CoMP information is shared among the PHS base stations. Note that the essential CoMP information may be transmitted either to all of the PHS base stations other than the PHS base station of its own or to a specific PHS base station.

Subsequently, the PHS base station 201a obtains information that allows determination whether the communication terminal 202 may connect to a plurality of PHS base stations 201. This information is, for example, a reception quality value of a radio wave calculated by the communication terminal 202 when the radio wave from the PHS base station 201 reaches the communication terminal 202. The reception quality value is the value of the SNR, CNR, SINR, CINR, or the like. According to the present embodiment, hereinafter, the information received by the PHS base station 201a from the communication terminal 202 is the reception quality value of the SNR. The greater the reception quality value of the SNR, the higher a connection possibility.

The communication terminal 202, when calculates the reception quality value of the radio wave from the PHS base station 201, associates the reception quality value with the identification information of the PHS base station 201 that is corresponding, such that the PHS base station 201 may be specified from the value of the radio wave. Then, the communication terminal 202, periodically or non-periodically, transmits the reception quality value associated with the identification information of the PHS base station 201 to the PHS base station 201a. For example, when the communication terminal 202 locates in a range (a cell) receivable of the radio wave from the base station 201a alone, the communication terminal 202 transmits the reception quality value corresponding to the PHS base station 201a alone to the PHS base station 201a.

Next, the communication unit 211a of the PHS base station 201a receives the reception quality value and transmits the reception quality value to the controller 217a (step S203). Then, the controller 217a stores the reception quality value in the storage unit 213a.

Subsequently, the controller 217a, based on the reception quality value, determines whether the communication terminal 202 may connect to a plurality of PHS base stations 201 (step S204). For example, the controller 217a compares the reception quality value to a threshold thereof that is necessary for stable communication of the communication terminal 202. This threshold may be preliminarily stored in the storage unit 213a. When the reception quality value corresponding to the PHS base station 201a alone connecting to the communication terminal 202 is equal to or greater than the threshold (No at step S204), the PHS base station 201a, without performing cooperation control with the other PHS base stations 201b and 201c, maintains the communication with the communication terminal 202.

Then, due to a change in a communication environment or movement of the communication terminal 202, when the reception quality values of the radio waves from the PHS base stations 201a and 201b become equal to or greater than the threshold, the controller 217a determines that there are a plurality of PHS base stations 201 (according to the present embodiment, two PHS base stations) to which the communication terminal 202 may connect (Yes at step S204) and proceeds to an operation at step S205.

At step 205, the controller 217a refers to the essential CoMP information and determines whether the PHS base stations 201a and 201b may perform the joint transmission. Then, when the controller 217a confirms that the PHS base station 201b has a radio resource the same as the radio resource (the same radio resource) assigned to the communication terminal 202 by the PHS base station 201a and is not using the same radio resource, the controller 217a carries out an operation of the joint transmission, which is one of the CoMP (step S206). In particular, the controller 217a generates a base station instruction signal for the PHS base station 201b to secure the same radio resource described above for the communication with the communication terminal 202 and establish a connection to the communication terminal 202. Then, the controller 217a controls the interface unit 215a to transmit the base station instruction signal to the PHS base station 201b via the remote radio units 207a and 207b and the wired line 209. Thereby, the CoMP may be performed by using the wired line 209 of the LTE base station 203.

According to the present embodiment, as described above, the controller 217 of the PHS base station 201 controls the interface unit 215 to transmit the essential CoMP information serving as the communication-related information of the PHS base station 201 to other PHS base stations 201 connected to the remote radio units 207 of the LTE base station 203 via the wired line 209. That is, via the LTE base station 203, the essential CoMP information is shared among a plurality of PHS base stations 201. Therefore, when the communication terminal 202 may connect to the PHS base stations 201a and 201b, the PHS base station 201a, based on the essential CoMP information, may specify the PHS base station 201b that may perform the joint transmission together with the PHS base station 201a. Then, the PHS base station 201a, by using line network of the LTE base station 203, may instruct the PHS base station 201b to perform the joint transmission to the communication terminal 202. In this manner, the PHS base station 201a, by using the LTE base station 203 that employs a different communication standard, may substantialize the communication using the CoMP.

Although the present disclosure has been described based on the figures and the embodiments, it is to be understood that various changes and modifications may be implemented based on the present disclosure by those who are ordinarily skilled in the art. Accordingly, such changes and modifications are included in the scope of the present disclosure.

For example, functions and the like included in each unit, each means, each step and the like may be rearranged without logical inconsistency, so as to combine a plurality of means or steps together or to divide them.

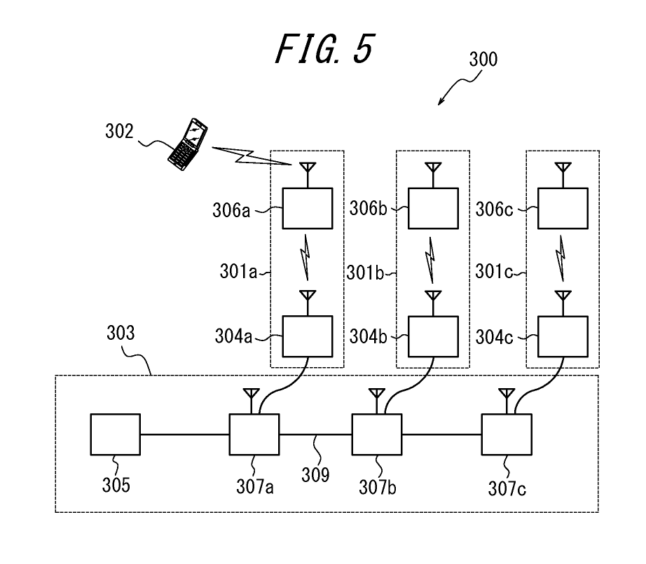

Although in the above embodiments each of a plurality of PHS base stations is represented by a signal housing, the disclosure herein is not limited thereto. As illustrated in FIG. 5, for example, PHS base stations 301 (301a, 301b, and 301c) of a communication system 300 may be constituted by using two housings: PHS radio stations 304 (304a, 304b, and 304c) and PHS relay stations 306 (306a, 306b, and 306c). In this case, the communication terminal 302 wirelessly communicates with the PHS relay stations 306, and the PHS relay stations 306 wirelessly communicates with the PHS radio stations 304, and the PHS radio stations 304 are connected to the remote radio units 307 of the LTE base station 303 via the wired line 309. The PHS radio stations 304 have a configuration the same as that in FIG. 2, and the PHS relay stations 306, other than the interface unit wirelessly connected to the PHS radio stations 304, has a configuration the same as that in FIG. 2. In this case, a connection destination of the communication terminal 302 after the handover is switched over among the PHS relay stations 306, and the CoMP is implemented as cooperative control among the PHS relay stations 306.

Further, although in the above embodiments the handover between the PHS base stations is described, the disclosure herein is not limited thereto. For example, the baseband unit of the LTE base station may control the remote radio unit to transmit the essential handover information of the remote radio unit to the PHS base station. In this case, the interface unit of the PHS base station receives the essential handover information from the remote radio unit connected to the interface unit. Thereby, the controller of the PHS base station may also obtain the essential handover information of the remote radio unit. Accordingly, the controller may change the connection destination of the communication terminal after the handover from the PHS base station to the remote radio unit of the LTE base station. Thereby, the handover may be performed for the purpose of traffic dispersion between the PHS base station and the LTE base station.

### REFERENCE SIGNS LIST

100 communication system

101a, 101b, 101c PHS base station (communication apparatus)

102 communication terminal

103 LTE base station

105 baseband unit

107a, 107b, 107c remote radio unit

109 wired line

111 communication unit

113 storage unit

115 interface unit

117 controller

1. A communication apparatus employing a communication standard different from that of a base station having a baseband unit and at least one remote radio unit connected to the baseband unit via a wired line, the communication apparatus comprising:
an interface unit connected to the remote radio unit; and
a controller for controlling the interface unit to transmit, via the wired line, communication-related information of the communication apparatus to at least one other communication apparatus connected to the remote radio unit.

2. The communication apparatus according to claim 1, wherein the communication-related information is information necessary to perform handover between the communication apparatus and the one other communication apparatus.

3. The communication apparatus according to claim 1, wherein the communication-related information is information necessary to perform CoMP (Coordinated Multi-Point) between the communication apparatus and the one other communication apparatus.

4. The communication apparatus according to claim 1, wherein the interface unit, from the remote radio unit connected to the interface unit, receives information necessary to perform handover to the remote radio unit.

5. The communication apparatus according to claim 1, wherein, when the base station is a base station employing an LTE (Long Term Evolution) system, the communication apparatus is a base station employing PHS (Personal Handy-phone System).

6. A communication system comprising a plurality of communication apparatuses according to claim 1, at least one remote radio unit connected to the communication apparatus, and a baseband unit.

7. A communication control method of a communication apparatus employing a communication standard different from that of a base station having a baseband unit and at least one remote radio unit connected to the baseband unit via a wired line, the communication control method comprising:
a step of connecting to the remote radio unit; and
a step of transmitting, via the wired line, communication-related information of the communication apparatus to at least one other communication apparatus connected to the remote radio unit.
